(19) United States
(12) Patent Application Publication
(10) Pub. No.: US 2025/0314102 A1
(43) Pub. Date: Oct. 9, 2025

(54) ANTI-THEFT METHOD AND ANTI-THEFT WIRE LOCK

(71) Applicant: SHENZHEN WINS ELECTRONIC TECHNOLOGY CO., LTD., Shenzhen (CN)

(72) Inventors: PINGCHENG GUO, Shenzhen (CN); SHENGFEI ZHAO, Shenzhen (CN)

(21) Appl. No.: 18/811,328

(22) Filed: Aug. 21, 2024

(30) Foreign Application Priority Data
Apr. 7, 2024 (CN) 202410407470.3

(51) Int. Cl. E05B 67/38; E05B 67/00

(52) U.S. Cl. CPC E05B 67/38; E05B 67/003

(57) ABSTRACT

The present invention discloses an anti-theft method for wire lock and the corresponding wire lock, by improving the structure of the lock body of wire lock, when the lock hole of wire lock is inserted for the first time, the structure of the lock body changes, so that the lock hole can not be inserted again, and the anti-theft effect of wire lock is improved.

### CROSS-REFERENCE TO RELATED APPLICATIONS

This application claims priority to Chinese Patent Application No. 202410407470.3, filed on Apr. 7, 2024, which is hereby incorporated by reference in its entirety.

### TECHNICAL FIELD

The present invention relates to a lock, in particular to an anti-theft wire lock.

### BACKGROUND

The wire lock is a kind of lock used in various fields, commonly used for containers, and the existing wire lock comprises a lock body with a wire rope, and the lock body has a one-way lock hole, and the one-way lock hole is a through-hole; When the wire rope is inserted into the one-way lock hole, the wire lock reports the locking signal to the background. Before containers' loading and shipment, the shipper confirms the locking signal remotely and issues a loading notification.

During the use of the wire lock, it was discovered that someone had created a false locking state to steal goods from the container; The false locking state is shown in FIG. 1, when locking, the thief first prepares a section of wire rope or similar, and inserts this section of wire rope or similar into the one-way lock hole, so that the wire lock reports the locking signal to the background, forms the illusion that it has been locked, and then carries out theft in the process of goods in transit. As shown in FIG. 2, pull out the self provided wire rope or similar object from the lower end of the one-way lock hole, and insert the wire rope of the wire lock into the one-way lock hole to form a locked state; In this way, the consignee will accept the goods as long as they see that the lock is intact and undamaged during the inspection. How to prevent the occurrence of the above situation is an urgent problem to be solved in the industry.

### SUMMARY

In order to solve the above technical problems, the present invention provides an anti-theft method, which is suitable for wire lock, when the lock hole of the wire lock is first inserted, the structure of the lock body is changed, the lock hole cannot be inserted again by the wire rope of the wire lock. When a thief attempts to steal goods by creating a false lock state, the wire rope of the wire lock itself cannot be inserted into the lock hole normally, thus achieving the anti-theft effect.

Furthermore, before the lock hole is inserted, the lock hole is in a state where the wire rope can be inserted. In the initial state, the wire rope can be inserted into the lock hole to ensure that the wire lock can be locked normally.

Furthermore, a blocking element is provided inside the lock body, and before the lock hole is inserted, the blocking element is located outside the wire rope channel, so that the lock hole is in an insertable state. The blocking element is initially located outside the wire rope channel, and it will not affect the normal entry of the wire rope into the lock hole for locking, so that the wire rope can be inserted normally when it is inserted for the first time.

Furthermore, a supporting element is provided inside the lock body, and before the lock hole is inserted, the blocking element is blocked by the supporting element and located outside the wire rope channel.

Furthermore, before the lock hole is inserted, the supporting element blocks the blocking element from entering the wire rope channel; When the lock hole is inserted for the first time, the supporting element is displaced, so that the supporting element no longer blocks the blocking element from entering the wire rope channel. The displacement of the supporting element can change the structure of the lock body. When the first inserted object is pulled out, the blocking element can enter the wire rope channel, thereby preventing the occurrence of false locking.

Furthermore, before the lock hole is inserted, the supporting element blocks the blocking element from entering the wire rope channel; When the lock hole is inserted for the first time, at least a portion of the supporting element near the blocking element is displaced, so that the supporting element no longer blocks the blocking element from entering the wire rope channel. In some scenarios, the release of the blocking element can be achieved solely by the displacement of the portion of the supporting element, such as the portion near the blocking element.

Furthermore, before the lock hole is inserted, the supporting element blocks the blocking element from entering the wire rope channel; When the lock hole is inserted for the first time, the supporting element rotates under the effect of the inserted object, so that the supporting element no longer blocks the blocking element from entering the wire rope channel. In some scenarios, the blocking element can be released by rotating the supporting element, and when the inserted object is pulled out, the blocking element can enter the wire rope channel, thereby preventing the occurrence of false locking.

Furthermore, before the lock hole is inserted, the supporting element blocks the blocking element from entering the wire rope channel; When the lock hole is inserted for the first time, the supporting element undergoes deformation under the effect of the inserted object, so that the supporting element no longer blocks the blocking element from entering the wire rope channel.

Furthermore, before the lock hole is inserted, the supporting element blocks the blocking element from entering the wire rope channel; When the lock hole is inserted for the first time, at least a portion of the supporting element detached from the wire rope channel, so that the supporting element no longer blocks the blocking element from entering the wire rope channel.

Furthermore, after the inserted object is removed, the blocking element enters into the wire rope channel, and the part of the passage area of the wire rope channel is blocked, so that the lock hole can no longer be inserted normally by the wire rope. After the insert is removed, the wire rope channel in the lock hole is blocked by the blocking element, and even if it is partially blocked, in some scenarios, the lock hole can no longer be inserted normally.

Furthermore, after the inserted object is removed, the blocking element enters into the wire rope channel, and the entire passage area of the wire rope channel is blocked, so that the lock hole can no longer be inserted normally by the wire rope. After the insert is removed, the wire rope channel in the lock hole is completely blocked by the blocking element, Eliminating the issue of gaps that may not have been properly blocked. the lock hole can no longer be inserted normally.

Furthermore, the blocking element enters into the wire rope channel under the action of the elastic element.

Furthermore, the blocking element is held against the elastic element which is in a compressed state, and after the inserted object is removed, the blocking element is pushed into the wire rope channel by the elastic element.

Furthermore, the elastic element is a spring.

Furthermore, the supporting element is a stop block.

Furthermore, the initial state of the stop block is held against the blocking element; When the lock hole is inserted for the first time, the stop block is separated from the inner wall of the lock hole. The stop block can fall out when the lock hole is inserted for the first time, and the one-time locking function of the lock hole is realized.

Furthermore, the stop block is provided in the wire rope channel, one end of the stop block is fixed to the inner wall of the lock hole, and the other end of the stop block is held against the blocking element; When the lock hole is inserted for the first time, the stop block is separated from the inner wall of the lock hole, and the stop block is detached from the wire rope channel. The supporting element is a ordinary stop block, and the stop block can fall out when the lock hole is inserted for the first time, and the one-time locking function of the lock hole is realized.

Furthermore, the supporting element is a rotating element. The rotating element can block or release the blocking element through rotation. And there will be no breakage or detachment like the stop block, which can also avoid the hidden danger of blocking the lock hole caused by fragments or debris, and can achieve anti-theft effect more smoothly and efficiently. It can be one of the preferred methods for mass production and use.

Furthermore, the initial state of the rotating element is held against the blocking element; When the lock hole is inserted for the first time, the rotating element rotates to release the blocking element. When the insertion is inserted for the first time, the rotating element is pushed by the insertion tip to rotate, which can release the blocking element. It can also ensure the smooth insertion of the first insert.

The present invention also provides an anti-theft wire lock, comprising:

A lock body, the lock body is provided with a lock hole;

A wire rope, one end of the wire rope is connected to the lock body, and the other end is used to insert into the lock hole for locking;
the lock body is provided with supporting element and blocking element inside; Before the lock hole is inserted for the first time, the supporting element holds against the blocking element; When the insert is pulled out, the blocking element blocks the lock hole. It can improve the anti-theft effect of the wire lock.

Optionally, the blocking element is an elastic element, and when the object inserted for the first time is pulled out, the elastic element releases elastic force to block the lock hole. When the blocking element is an elastic element, it can block the wire rope channel by using its own structure through the release and deformation of its own elastic force.

Furthermore, the elastic element is a spring. By releasing the elastic force of the spring, it undergoes deformation, and the wire rope channel can be blocked by the spring itself, achieving a simple and efficient anti-theft effect.

Optionally, the blocking element is connected with an elastic element, and when the object inserted is pulled out, the blocking element is pushed by the elastic element to block the lock hole.

Furthermore, the elastic element is a spring.

Furthermore, the lock body further comprises a sliding sleeve inside, the blocking element and the elastic element are provided inside the sliding sleeve, and the blocking element is in a sliding fit with the inner surface of the sliding sleeve. By setting up the sliding sleeve, the dynamic friction of the blocking element can be reduced, ensuring that when the insert is pulled out, the blocking element can smoothly block the lock hole, while improving the stability and service life of the structure.

Furthermore, the blocking element is cylindrical. The cylindrical shape has good mechanical properties, which can ensure the stability of the anti-theft wire lock.

Optionally, the supporting element is a stop block, one end of the stop block is fixed to the inner wall of the lock hole, and the other end of the stop block is held against the blocking element, When the lock hole is inserted for the first time, the stop block is separated from the inner wall of the lock hole. The stop block can fall out when the lock hole is inserted for the first time. And the one-time locking function of the lock hole is realized.

Optionally, the supporting element is a rotating element, the rotating element can rotate around a rotating shaft, and the rotating element holds against the blocking element; The rotating element is capable of rotating to release the blocking element. When the lock hole is inserted for the first time, the rotating element is pushed by the insertion tip to rotate, which can release the blocking element. It can also ensure the smooth insertion of the first insert. The rotating element can block or release the blocking element through rotation. And there will be no breakage or detachment like the stop block, which can also avoid the hidden danger of blocking the lock hole caused by fragments or debris, and can achieve its anti-theft effect more smoothly and efficiently. It can be one of the preferred methods for mass production and use.

Furthermore. The abutting part of the rotating element and The abutting part of the blocking element are matched through concave and convex surfaces. Through the combination of concave and convex surfaces, the wire lock maintains a stable state before use and during transportation, It can avoid the displacement of rotating parts and the incorrect blocking of lock holes.

Furthermore, the rotating element is provided with a concave portion, and the blocking element is provided with a convex portion. This can improve the anti vibration ability and stability of the wire lock during transportation.

Furthermore, a positioning component is provided inside the lock body, and one end of the rotating element is held against the blocking element, and the other end is held against the positioning component.

Furthermore. The abutting part of the rotating element and The abutting part of the positioning component are matched through concave and convex surfaces.

Furthermore, the rotating element is provided with a convex portion, and the positioning component is provided with a concave portion.

Furthermore, the rotating element is L-shaped. In the initial state, the rotation axis position of the rotating element, the contact position between the rotating element and the blocking element, and the contact position between the rotating element and the positioning component together form a triangular structure as a whole. In this way, it is convenient to cooperate with other supporting components to achieve a rotatable structure, which can further improve the stability of its initial state and enable smooth switching between maintaining or rotating states.

Furthermore, a one-way lock cylinder is further provided inside the lock body.

The anti-theft method and anti-theft wire lock provided by the present invention, When the person who locks the goods steals the goods by creating a false locking state, the wire rope of the wire lock itself can no longer be inserted into the lock hole normally, When the goods reach the predetermined or designated position, the wire lock will inevitably be in an unlocked state, and the recipient can refuse to receive the goods. it can prevent theft.

### BRIEF DESCRIPTION OF DRAWINGS

FIG. 1 is the first schematic diagram of the false lock state described in the background technology;

FIG. 2 is the second schematic diagram of the false lock state described in the background technology;

FIG. 3 is a schematic diagram of the overall structure of the anti-theft wire lock of the present invention;

FIG. 4 is a schematic diagram of the structure of the wire lock in the present invention, which uses a stop block as the supporting element and a spring as the blocking element;

FIG. 5 is a schematic diagram of the structure of the wire lock in the present invention, which uses a stop block as the supporting element and a rigid element as blocking element.

FIG. 6 is a schematic diagram of the structure of the wire lock in the present invention, which uses a rotating element as the supporting element and a rigid element as the blocking element.

FIG. 7 is an enlarged partial view of FIG. 6;

FIG. 8 is a schematic diagram of the structure of the wire lock in the present invention with a positioning module.

1—Lock body; 2—Wire rope; 3—Lock hole; 4—First spring; 5—Second spring; 6—Rigid element; 7—Sliding sleeve; 8—Stop block; 9—Rotating element; 10—Rotating shaft; 11—Concave portion; 12—Concave portion; 13—One-way lock cylinder; 14—Positioning module; 15—T-shaped rail; 16—T-shaped slider.

### DETAILED DESCRIPTION OF THE EMBODIMENTS

In order to enable those skilled in the art to better understand the technical scheme of the present invention, the present invention is further described in detail below in conjunction with the specific embodiment.

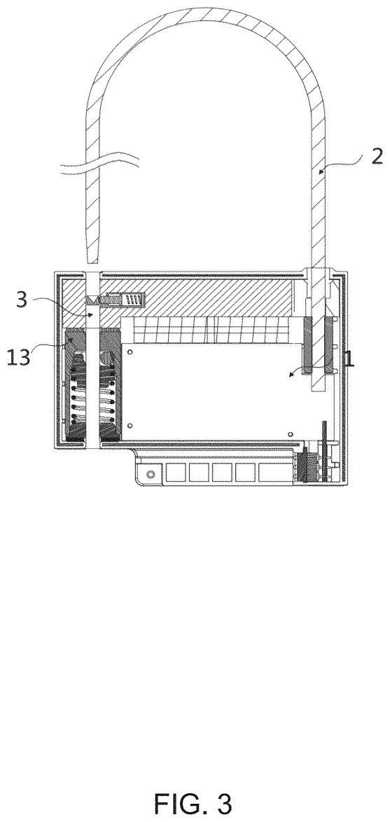

The embodiment provides an anti-theft method for the wire lock, the lock body 1 of the wire lock is shown in FIG. 3, and the lock body 1 of the wire lock is optimized so that when the lock hole 3 is inserted for the first time, the structure of the lock body 1 changes, so that the lock hole 3 cannot be inserted again.

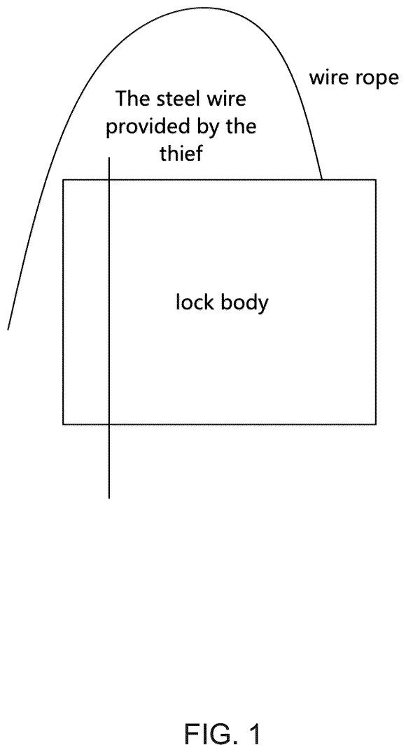

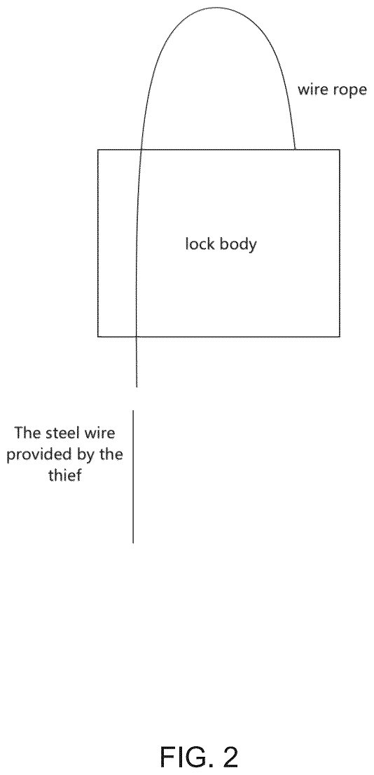

In this embodiment, the lock hole 3 can only be inserted once by an insert. When the insert is inserted into the lock hole 3, it will cause a change in the internal structure of the lock body. When the insert is pulled out, the lock hole 3 is blocked and cannot be inserted a second time. As shown in FIGS. 1 and 2, when the theft steals goods by creating a false locked state, it is no longer possible to insert the wire rope 2 of the wire lock into the lock hole 3.

In this embodiment, the “change in structure” is manifested as the displacement of the internal structure of lock body 1, which blocks lock hole 3. Before the lock hole 3 is inserted, it is in a state where it can be inserted normally. For the first insertion, when the first insertion is wire rope 2 of the wire lock, it means that the wire lock is locked normally.

According to one embodiment of the present invention, a blocking element is provided in the lock body 1 of the wire lock. Before the lock hole 3 is inserted, the blocking element is located outside the wire rope channel, and will not affect the insertion of the wire rope 2, so that the lock hole 3 is in an insertable state. The lock body 1 of the wire lock is provided with a supporting element, and before the lock hole 3 is inserted, the blocking element is blocked by the supporting element and located outside the wire rope channel. After the insert is inserted, the insertion end of the insert will apply force to the supporting element, so that the supporting element no longer blocks the blocking element from entering the wire rope channel.

The supporting element can be displaced or deformed, such as:

When the lock hole 3 is inserted for the first time, the supporting element is displaced, so that the supporting element no longer blocks the blocking element from entering the wire rope channel.

When the lock hole 3 is inserted for the first time, the portion of the supporting element close to the blocking element is displaced, so that the supporting element no longer blocks the blocking element from entering the wire rope channel.

When the lock hole 3 is inserted for the first time, the supporting element rotates under the effect of the inserted object, so that the supporting element no longer blocks the blocking element from entering the wire rope channel.
before the lock hole 3 is inserted, the supporting element blocks the blocking element from entering the wire rope channel; When the lock hole 3 is inserted for the first time, the supporting element undergoes deformation, so that the supporting element no longer blocks the blocking element from entering the wire rope channel.

When the lock hole 3 is inserted for the first time, the supporting element is detached from the wire rope channel, so that the supporting element no longer blocks the blocking element from entering the wire rope channel.

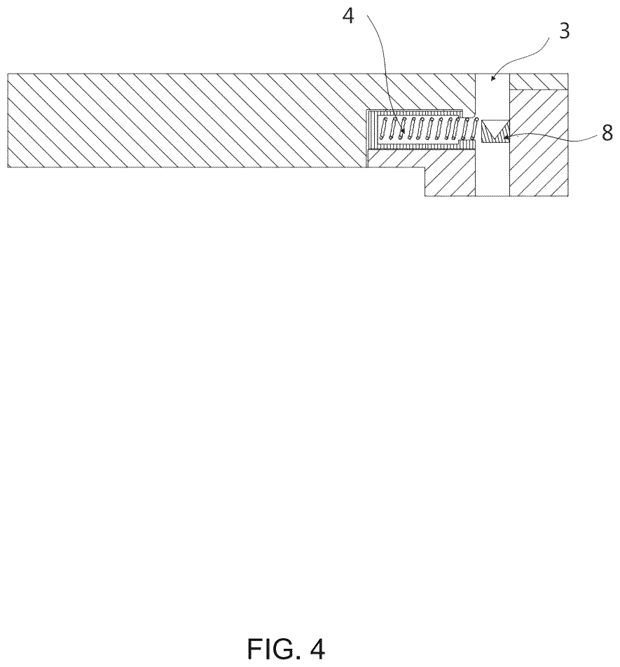

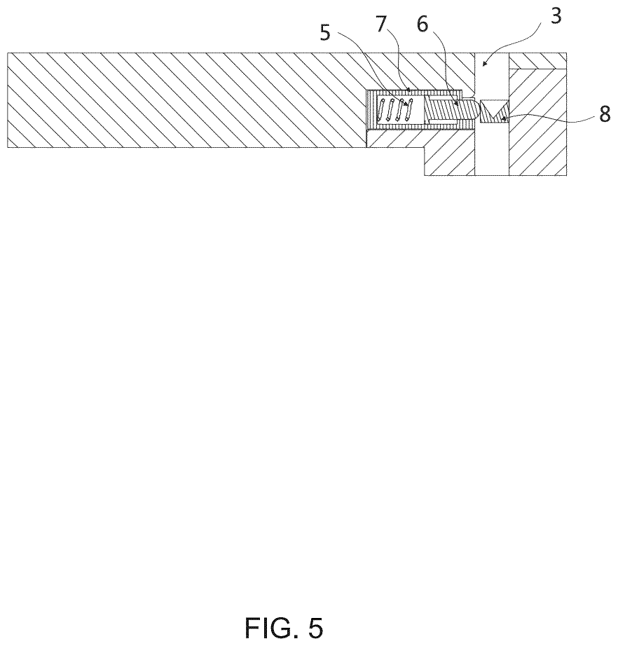

The supporting element can be a stop block 8, as shown in FIG. 4 and FIG. 5, the tip of the insert pushes the stop block 8 to move downward, and after the tip of the insert passes through the blocking plane of the blocking element, the stop block 8 falls out of the lock hole 3. When the insert is pulled out, the blocking element is no longer blocked by other objects, the lock hole 3 can be blocked.

The supporting element can be a bar, one end of which is held against the blocking element, and the other end is fixed to the inner wall of the lock hole 3, when the insert is inserted into the lock hole 3, the tip of the insert forces the bar to undergo plastic deformation and no longer blocks the blocking element, and after the bar undergoes plastic deformation, the bar is attached to the inner wall of the lock hole 3. When the insert is pulled out, the lock hole 3 can be blocked by the blocking element, because the blocking element is no longer blocked by other objects.

The supporting element can be a rotatable object, When the insert is inserted, the rotatable object rotates, And no longer blocks the sealing components. After the insert is pulled out, the locking hole 3 can be blocked, because the blocking element is no longer blocked by other objects.

The supporting element can be a brittle object. When the insert is inserted. The brittle object was destroyed into fragments. and no longer blocks the blocking element. After the insert is pulled out, the locking hole 3 can be blocked, because the blocking element is no longer blocked by other objects.

According to an embodiment of the present invention, after the object inserted is taken out, the blocking element enters into the wire rope channel, and the part passing area of the wire rope channel is blocked, so that the wire rope 2 of the wire lock can no longer be inserted into the lock hole 3. For example, more than ⅔ of the wire rope channel are blocked, and the remaining part is not enough for other inserts to be inserted.

According to an embodiment of the present invention, when the object inserted is taken out, the blocking element enters the wire rope channel, blocks the entire passing area of the wire rope channel, and the wire rope 2 cannot be inserted into the lock hole 3.

According to an embodiment of the present invention, the blocking element itself is an elastic element, and the elastic element is a spring, as shown in FIG. 4, in order to facilitate distinction, the spring which is separately used as the blocking element is called the first spring 4, the first spring 4 is in a compressive state under the support of the supporter, and when the supporting element moves, the first spring 4 releases the elastic force, makes one end of it move, enters into the wire rope channel, and blocks the wire rope channel.

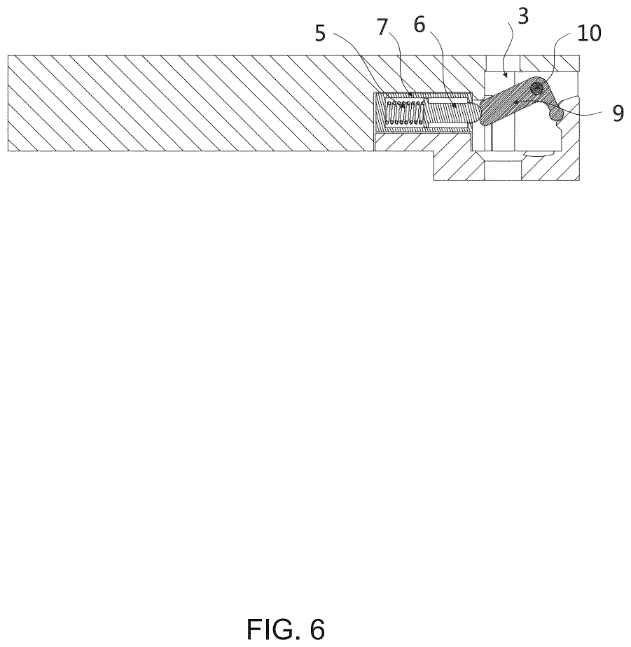

According to an embodiment of the present invention, the blocking element can additionally connect an elastic element, the elastic element is a spring, as shown in FIG. 5 and FIG. 6, in order to facilitate distinction, the blocking element does not have elasticity in this embodiment, but achieves blocking through the elastic force of the spring, the spring in this embodiment called the second spring 5, the second spring 5 is in a compression state under the support of the supporting element, after the supporting element moves, the second spring 5 releases the elastic force, and the blocking element enters the wire rope channel under the effect of the second spring 5. In this embodiment, the blocking element is held against the second spring 5 in a compressed state, and after the object inserted is taken out, the blocking element is pushed into the wire rope channel by the second spring 5.

According to an embodiment of the present invention, the embodiment provides an anti-theft wire lock, as shown in the figure, the anti-theft wire lock comprising: A lock body 1, the lock body 1 is provided with a lock hole 3;

A wire rope 2, one end of the wire rope 2 is connected to the lock body 1, and the other end is used to insert into the lock hole 3 for locking;
the lock body 1 is provided with a blocking element and a supporting element inside; the supporting element is used for blocking the blocking element before the lock hole 3 is inserted for the first time; The blocking element is used for blocking the lock hole 3 when the insert is pulled out.

According to an embodiment of the present invention, the blocking element itself is an elastic element, and when the object inserted for the first time is pulled out, the elastic element releases elastic force to block the lock hole 3. As shown in FIG. 4, the blocking element in the present embodiment is the first spring 4, the first spring 4 is in a compression state under the support of the supporting element at the initial time, when the first insert is inserted, the insertion end can exert force to the supporting element, the supporting element moves, the supporting element no longer blocks the first spring 4, when the object inserted is pulled out, the first spring 4 releases elastic potential energy, and one end of the first spring 4 enters the wire rope channel, and the lock hole 3 is blocked.

According to an embodiment of the present invention, the blocking element is additionally connected with an elastic element, and when the object inserted is pulled out, the blocking element is pushed by the elastic element to block the lock hole 3. As shown in FIGS. 5 and 6, in this embodiment, the blocking element itself is an inelastic element, the blocking element is a rigid element 6, which is connected to a second spring 5, the second spring 5 is in a compression state initially, when the object inserted is pulled out, the second spring 5 releases elastic potential energy, and the second spring 5 pushes the blocking element to enter the wire rope channel, and blocks the lock hole 3.

Further, as shown in FIGS. 5 and 6, in this embodiment, there is a sliding sleeve 7 outside the rigid element 6 and the elastic element 5, and the rigid element 6 is sliding and fits with the inner surface of the sliding sleeve 7 when the rigid element 6 is pushed by the elastic element 5. Lubricant can be provided inside the sliding sleeve 7 to reduce the dynamic friction between the rigid element 6 and the sliding sleeve 7, and ensure that when the insert is pulled out, the rigid element 6 can smoothly block the lock hole 3.

Further, in this embodiment, the blocking element is cylindrical, one end of the blocking element is connected to the elastic element, and the axis of the other end is facing the axis of the lock hole 3, when the insert is pulled out from the lock hole 3, the blocking element enters into the lock hole 3 under the effect of the elastic element, and the lock hole 3 is transversely blocked, and the blocking element blocks the partial passage area of the wire rope channel, so that the lock hole 3 can no longer be inserted.

Further, the blocking element is cylindrical, one end of the blocking element is connected to the elastic element, the axis of other end is facing the axis of the lock hole 3, and the blocking element has a curved surface that is compatible with the side wall of the lock hole 3, so as to ensure that when the lock hole 3 is blocked by the blocking element, the entire passing area of the wire rope channel can be blocked, so that the lock hole 3 can no longer be inserted.

According to an embodiment of the present invention, as shown in FIG. 6, the supporting element is a rotating element 9, the rotating element 9 is fixed through a rotating shaft 12, and the rotating element 9 holds against the blocking element; The rotating element 9 can rotate under the action of the first insert to release the blocking element. The rotating element 9 has the first working position and the second working position, the rotating element 9 is held against the blocking element when it is in the first working position, and the rotating element 9 is released when it is in the second working position. As shown in FIG. 6, the blocking element is a rigid element 6, it is connected to the second spring 5, the rotating element 9 is in the first working position at the initial time, the second spring 5 is in a compression state at this moment, the rigid element 6 does not block the lock hole 3, when the wire rope 2 or other similar objects are inserted, the tip of the insert pushes the rotating element 9 from the first working position to the second working position, when the wire rope 2 or other similar objects are pulled out, this second spring 5 releases elastic force to push the rigid element 6, blocks this lock hole 3, so that the lock hole 3 cannot be inserted again.

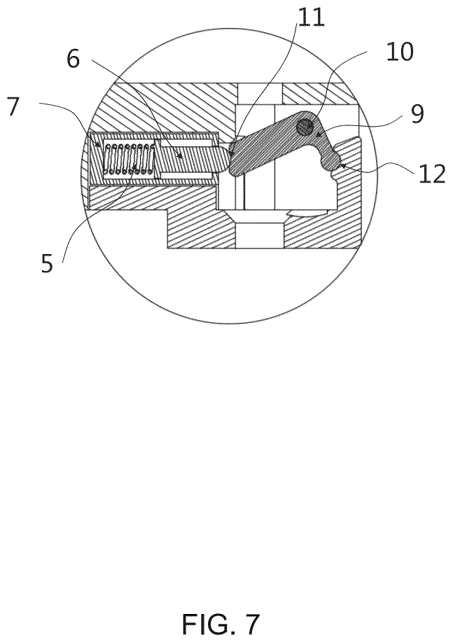

In this embodiment, as shown in FIG. 7. The abutting part of the rotating element 9 and The abutting part of the rigid element 6 are matched through concave and convex surfaces. The rotating element is provided with a concave portion 11, and the blocking element is provided with a convex portion.

Further, as shown in FIG. 7, in this embodiment, a positioning portion is further provided inside the lock body 1, a concave portion 12 is on the positioning portion, and when the rotating element 9 is in the first working position, one end of the rotating element 9 is held against the blocking element, and the other end is held against the concave portion 12. In order to facilitate the rotation element 9 to be fixed at the initial position (i.e. the first working position),

in this embodiment, a concave portion 12 is provided inside the lock body 1, a concave portion 11 is also provided on the rotating element 9, and in the initial state, one end of the rotating element 9 with the concave portion 11 is held against the blocking element, and the other end of the rotating element 9 is held against the concave portion 12. In this embodiment, as shown in FIG. 5, the cross-section of the rotating element 9 is L-shaped, the rotation axis position of the rotating element, the contact position between the rotating element and the blocking element, and the contact position between the rotating element and the positioning portion together form a triangular structure as a whole, so that the stability of its initial state is ensured. When the wire rope 2 is inserted, the tip of the insert acts on the rotating element 9, so that the end held against the blocking element moves downward, and the end held against the concave portion 12 is moved upwards, so that the blocking element is released.

According to an embodiment of the present invention, the lock body 1 is also provided with one-way lock cylinder 13, this one-way lock cylinder 13 is used for receiving the wire rope 2 to realize locking, the one-way lock cylinder 13 is connected with a detection circuit, when the wire rope 2 is inserted into the lock hole 3, this one-way lock cylinder 13 receives this wire rope 2 to realize locking, the detection circuit that is located inside this lock body 1 is turned on at this moment, and then the locking signal is recognized, when the wire rope 2 is artificially destroyed, after being cut off, then this detection circuit will be broken again to identify the disconnect signal.

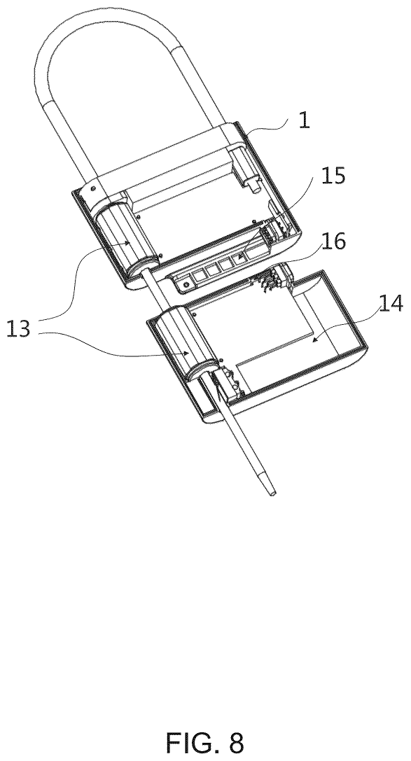

According to an embodiment of the present invention, as shown in FIG. 8, the anti-theft wire lock further comprises a positioning module 14, a one-way lock cylinder 13 is provided inside the positioning module 14, and the one-way lock cylinder 13 is used for receiving a wire rope 2 that passes through the lock hole 3. Through the positioning module 14, the background can understand the position of container and its locking state in real time. which helps to monitor the entire transportation process of the container.

In this embodiment, as shown in FIG. 8, the positioning module 14 is connected with the lock body 1 through a detachable structure, a power supply is provided inside the lock body 1, and the power supply is used for supplying power to the detection circuit and the positioning module 14. In this embodiment, the detachable structure is a T-shaped structure, and the T-shaped structure comprises a T-shaped rail 15 and a T-shaped slider 16 that is slidably matched with the T-shaped rail 15, wherein a T-shaped rail 15 is provided on the lock body 1, and a T-shaped slider 16 is provided on the positioning module 14.

In order to increase the integrity of the wire lock, the positioning module 14 and the lock body 1 in the embodiment adopt a detachable connection, the positioning module 14 is connected to the lock body 1 through the T-shaped structure before the wire lock is locked, after the positioning module 14 is connected to the lock body 1, the wire rope 2 first passes through the lock hole 3 and is then inserted into the one-way lock cylinder 13 on the positioning module 14; Then the wire lock is conveniently locked.

Further, conductive protrusions can be provided on the surface of the T-shaped slider 16, contact points matched with the conductive protrusions are provided on the T-shaped rail 15, when the positioning module 14 is connected to the lock body 1 through the T-shaped rail 15, the conductive protrusions are in contact with the contact points and conducted, in this embodiment, the positioning module 14 is supplied with power through a power supply provided inside the lock body 1, and the power supply transmits electric energy to the positioning module 14 through the conductive protrusions and the contact points. Since the positioning module 14 is a recyclable component, in order to avoid battery replacement, its power supply is set inside the lock body 1. The lock body 1 is a disposable component, and the disassembled positioning module 14 is matched with a new lock body 1 when reused. After being matched with the lock body 1 through the T-shaped slider 16, it can be powered on, This embodiment can improve the convenience of repeated use of the positioning module 14.

The above is only the preferred embodiment of the present invention, and it should be noted that the preferred embodiment shall not be regarded as a restriction on the present invention, and the scope of protection of the present invention shall be subject to the scope limited by the claims. For a person skilled in the art, a number of improvements and embellishments may also be made without departing from the spirit and scope of the present invention, and these improvements and embellishments shall also be regarded as the scope of protection of the present invention.

What is claimed is:

1. An anti-theft method for wire lock, the method comprising:
when the lock hole of the wire lock is inserted for the first time, the structure of the lock body is changed, and then the wire rope of the wire lock cannot be inserted into the lock hole;
before the lock hole is inserted, the lock hole is in a state where the wire rope can be inserted, the blocking element is blocked by the supporting element and located outside the wire rope channel.

2. The anti-theft method according to claim 1, wherein When the lock hole is inserted for the first time, at least a portion of the supporting element is displaced.

3. The anti-theft method according to claim 1, wherein When the lock hole is inserted for the first time, the supporting element rotates under the effect of the inserted object.

4. The anti-theft method according to claim 1, wherein When the lock hole is inserted for the first time, the supporting element undergoes deformation.

5. The anti-theft method according to claim 1, wherein When the lock hole is inserted for the first time, the supporting element is at least partially detached from the wire rope channel.

6. The anti-theft method according to claim 1, wherein after the inserted object is removed, the blocking element enters into the wire rope channel, and at least part of the passage area of the wire rope channel is blocked.

7. The anti-theft method according to claim 1, wherein the blocking element is held against the elastic element which is in a compressed state;
and after the inserted object is removed, the blocking element is pushed into the wire rope channel by a elastic element.

8. The anti-theft method according to claim 7, wherein the elastic element is a spring.

9. The anti-theft method according to claim 1, wherein the supporting element is a stop block; and the initial state of the stop block is held against the blocking element;
When the lock hole is inserted for the first time, the stop block is separated from the inner wall of the lock hole.

10. The anti-theft method according to claim 1, wherein the supporting element is a rotating element; and the initial state of the rotating element is held against the blocking element;
When the lock hole is inserted for the first time, the rotating element rotates to release the blocking element.

11. An anti-theft wire lock, comprising:
a lock body, the lock body is provided with a lock hole;
a wire rope, one end of the wire rope is connected to the lock body, and the other end is used to insert into the lock hole for locking;
the lock body is provided with a supporting element and a blocking element inside, Before the lock hole is inserted for the first time, the supporting element holds against the blocking element; When the insert is pulled out, the blocking element blocks the lock hole.

12. The anti-theft wire lock according to claim 11, wherein the blocking element is an elastic element;
when the insert is pulled out, the elastic element releases elastic force to block the lock hole.

13. The anti-theft wire lock according to claim 11, wherein the blocking element is connected with an elastic element;
when the insert is pulled out, the blocking element is pushed by the elastic element to block the lock hole.

14. The anti-theft wire lock according to claim 12, wherein the elastic element is a spring.

15. The anti-theft wire lock according to claim 13, wherein the lock body further comprises a sliding sleeve inside, the blocking element and the elastic element are provided inside the sliding sleeve.

16. The anti-theft wire lock according to claim 13, wherein the blocking element is cylindrical.

17. The anti-theft wire lock according to claim 11, wherein the supporting element is a stop block, one end of the stop block is fixed to the inner wall of the lock hole, and the other end of the stop block is held against the blocking element;
When the lock hole is inserted for the first time, the stop block is separated from the inner wall of the lock hole.

18. The anti-theft wire lock according to claim 11, wherein the supporting element is a rotating element, the rotating element can rotate around a rotating shaft, and the rotating element holds against the blocking element.

19. The anti-theft wire lock according to claim 18, wherein The abutting part of the rotating element and The abutting part of the blocking element are matched through concave and convex surfaces;
a positioning component is provided inside the lock body, and one end of the rotating element is held against the blocking element, and the other end of the rotating element is held against the positioning component;
The abutting part of the rotating element and The abutting part of the positioning component are matched through concave and convex surfaces.

20. The anti-theft wire lock according to claim 18, wherein the rotating element is L-shaped.
